(19) United States
(12) Patent Application Publication
(10) Pub. No.: US 2026/0197704 A1
(43) Pub. Date: Jul. 9, 2026

(54) CHARGING FOR PDU SETS IN A WIRELESS COMMUNICATION NETWORK

(71) Applicant: Lenovo (Singapore) Pte. Limited, Singapore (SG)

(72) Inventors: Dimitrios Karampatsis, Ruislip (GB); Apostolis Salkintzis, Glika Nera (GB); Genadi Velve, Darmstadt (DE)

(73) Assignee: Lenovo (Singapore) Pte. Limited, Singapore (SG)

(21) Appl. No.: 19/132,137

(22) PCT Filed: Jan. 10, 2023
(86) PCT No.: PCT/EP2023/050434

§ 371 Date: May 22, 2025

(30) Foreign Application Priority Data
Nov. 23, 2022 (GR) 20220100963

(51) Int. Cl. H04W 28/06; H04W 28/02; H04W 36/36; H04W 76/30

(52) U.S. Cl. CPC H04W 28/06; H04W 28/0268; H04W 36/362; H04W 76/30

(57) ABSTRACT

There is further provided a method in a network node of a wireless communication system, the method comprising: determining that the QoS parameters of at least one PDU-set cannot be fulfilled for a downlink PDU-set, the downlink PDU-set intended for delivery to a UE; discarding the at least one downlink PDU-set for which the QoS parameters cannot be fulfilled; and reporting information indicating the at least one discarded PDU-set of the UE to a first network function.

### FIELD

The subject matter disclosed herein relates generally to the field of implementing charging for PDU sets in a wireless communication network. This document defines a network node of a wireless communication system and a method in a network node of a wireless communication system.

### BACKGROUND

Herein, extended Reality (XR) is used as an umbrella term for different types of realities of which Virtual Reality, Augmented Reality, and Mixed Reality are examples.

XR application traffic is subject to strict bandwidth and latency limitations in order to deliver an appropriate Quality of Service (QoS) and Quality of Experience (QoE) to an end user of an XR service. Such strict bandwidth and latency limitations can make delivery of XR application traffic over a wireless communication network challenging.

In the context of XR media traffic, 3GPP SA2 Work Group recently introduced the concept of a Protocol Data Unit Set (PDU set) to group a series of PDUs carrying a unit of information at the application-level. Each PDU within a PDU set can thus be treated according to an identical set of QoS requirements and associated constraints of delay budget and error rate while providing support to a RAN for differentiated QoS handling at PDU set level. This improves the granularity of legacy 5G QoS flow framework allowing the RAN to optimize the mapping between QoS flow and DRBs to meet stringent XR media requirements (e.g., high-rate transmissions with short delay budget).

### SUMMARY

A base station such as an NG-RAN may drop packets of a PDU-set in case of, for example, congestion. As a PDU-set may contain a plurality of PDUs, the NG-RAN dropping all the PDUs of a PDU-set may result in charging inconsistency given that the UPF marks packets sent in the downlink and reports the number of packets sent over the downlink to the charging function.

Disclosed herein are procedures for charging for PDU sets in a wireless communication network. Said procedures may be implemented by way of a network node of a wireless communication system, and a method in a network node of a wireless communication system.

There is provided a network node of a wireless communication system, the network node comprising: a processor; and a memory coupled with the processor. The processor is arranged to cause the network node to: determine that the QoS parameters of at least one PDU-set cannot be fulfilled for a downlink PDU-set, the downlink PDU-set intended for delivery to a UE; discard the at least one downlink PDU-set for which the QoS parameters cannot be fulfilled; and report information indicating the at least one discarded PDU-set of the UE to a first network function.

There is further provided a method in a network node of a wireless communication system, the method comprising: determining that the QoS parameters of at least one PDU-set cannot be fulfilled for a downlink PDU-set, the downlink PDU-set intended for delivery to a UE; discarding the at least one downlink PDU-set for which the QoS parameters cannot be fulfilled; and reporting information indicating the at least one discarded PDU-set of the UE to a first network function.

The network node may comprise an NG-RAN. The first network function may comprise an AMF. The information indicating the at least one discarded PDU-sets may comprise a PDU-set data usage report. Where the first network function is not a charging function (CHF), the first network function may pass the reported information to the charging function (CHF).

As a result of the report of information indicating discarded PDU-sets to the first network function, this information can be passed on to a Charging Function (CHF), which is then able to remove from charging records PDUs that were dropped by the network node. As such, the charging records accurately reflect the PDUs that were delivered over the downlink, compensating for discarded PDUs.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for charging for PDU sets in a wireless communication network will now be described, by way of example only, with reference to the accompanying drawings, in which:

FIG. 1 depicts an embodiment of a wireless communication system for charging for PDU sets in a wireless communication network;

FIG. 2 depicts a user equipment apparatus;

FIG. 3 depicts further details of the network node;

FIG. 4 illustrates an overview of a core network XRM architecture handling of PDU sets;

FIG. 5 illustrates a SMF Secondary RAT Usage Data Reporting procedure;

FIG. 6 illustrates a method for charging for PDU sets in a wireless communication network; and

FIG. 7 illustrates a method in a network node of a wireless communication system.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram. The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

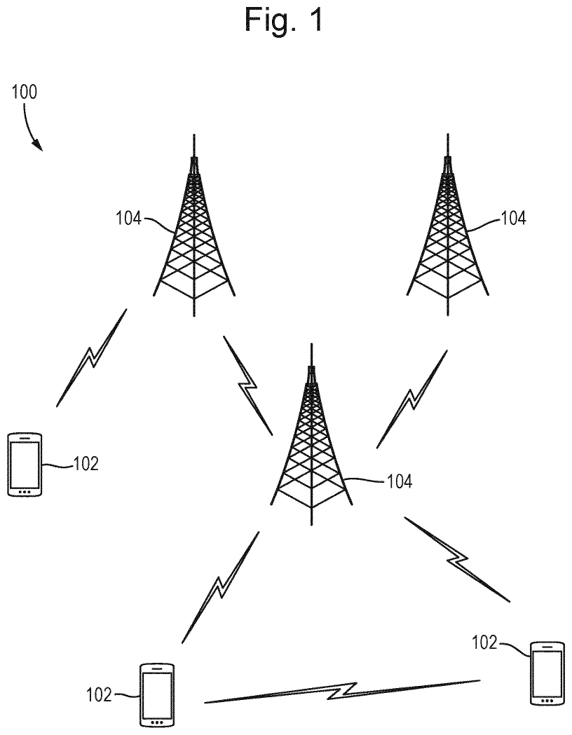

FIG. 1 depicts an embodiment of a wireless communication system 100 for implementing charging for PDU sets in a wireless communication network as described herein. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may comprise a user equipment apparatus 200 or a UE 435 as described herein. The base unit 104 may comprise a network node 300, a RAN 430, a RAN 530, or an NG-RAN node 630 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), a charging function (“CHF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

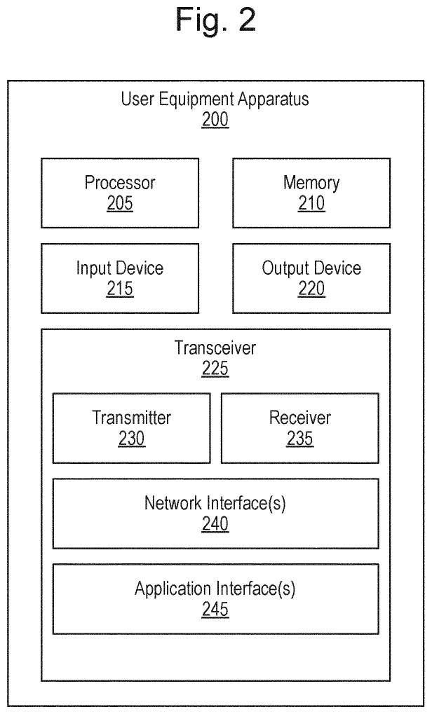

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102 or a UE 435 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module.

Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

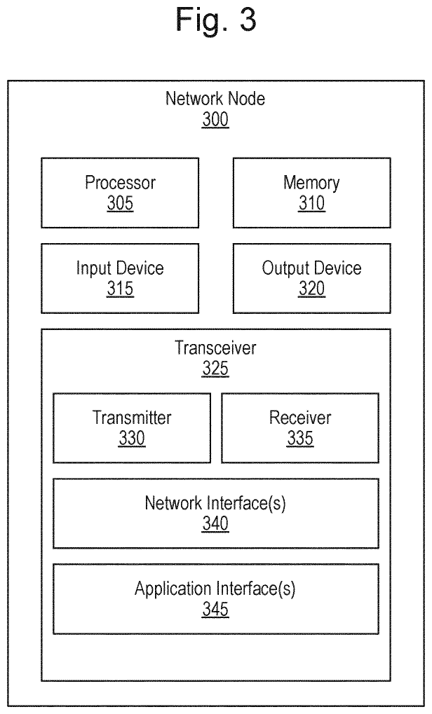

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a base unit 104, a RAN 430, a RAN 530, or an NG-RAN node 630 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

In Release 18, 3GPP is studying enhancements to support XR (extended reality) media within 3GPP core network. The main principle of solutions being discussed is to allow the core network to guarantee delivery of media packets that are important at the application level for recovering the media traffic even when the media packet is sent via a best effort bearer.

Most of the solutions proposes in 3GPP SA2 propose that the network identify important packets in a PDU-set. The PDU-set terminology in 3GPP TR 23.700-60 is as follows:
PDU Set: A PDU Set is composed of one or more PDUs carrying the payload of one unit of information generated at the application level (e.g. a frame or video slice for XRM Services, as used in TR 26.926. In some implementations all PDUs in a PDU Set are needed by the application layer to use the corresponding unit of information. In other implementations, the application layer can still recover parts all or of the information unit, when some PDUs are missing.

PDU-set specific QoS requirements may be defined that are either pre-configured in the 3GPP core network or provided by an AF. The QoS requirements for a PDU-set may be defined using any combination of the following parameters:
PDU Set Delay Budget (PSDB);
PDU Set Error Rate (PSER); and
Whether a PDU is essential.

PDU Set Delay Budget (PSDB) defines an upper bound for the time that a PDU-Set may be delayed between the UE and the N6 termination point at the UPF. PSDB applies to the DL PDU-Set received by the UPF over the N6 interface, and to the UL PDU-Set sent by the UE,

PDU Set Error Rate (PSER) defines a ratio of dropped PDU-set by NG-RAN compared to total PDU-set sent to the UE.

Whether a PDU is essential indicates whether all PDUs of a PDU-set are required by a receiver.

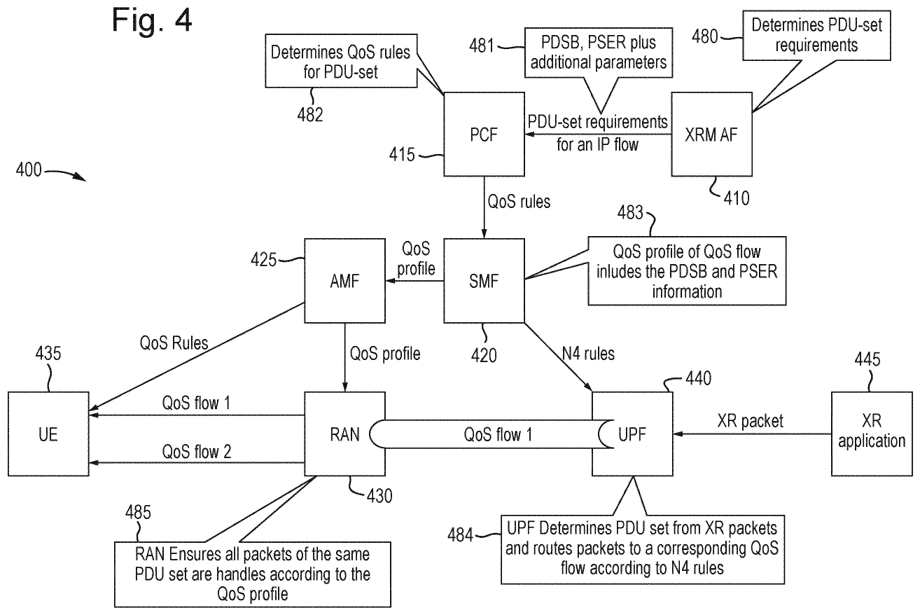

The packets belonging to a PDU-set are handled by the core network as shown in FIG. 4 which illustrates an overview of a core network (CN) XRM architecture handling of PDU sets. FIG. 4 shows a system 400 comprising an Extended Reality Media Application Function (XRM AF) 410, a Policy and Control Function (PCF) 415, a Session Management Function (SMF) 420, an Access and Mobility Function (AMF) 425, a Radio Access Network (RAN 430, a User Equipment (UE) 435, a User Plane Function (UPF) 440, and an Extended Reality Application 445. The UE 435 may comprise a remote unit 102 or a user equipment apparatus 200 as described herein. The RAN 430 may comprise a base unit 104, a network node 300, a RAN 530, or an NG-RAN node 630 as described herein. The operation of system 400 will now be described in the example of downlink traffic, a similar process may operate for uplink traffic.

At 480, the XRM AF 410 determines PDU set requirements.

At 481, the XRM Application Function 410 provides QoS requirements for packets of a PDU set to the PCF 415 and information to identify the application (i.e. 4-tuple or application id). The QoS requirements may comprise PSDB and PSER. The XRM AF 410 may also include an importance parameter for a PDU set and information for the core network to identify packets belonging to a PDU set.

At 482, the PCF 415 derives QoS rules for the XR application and specific QoS requirements for the PDU set. The QoS rules may use a 4G QoS identifier (5Q1) for XR media traffic. The PCF 415 sends the QoS rules to the SMF 420. The PCF 415 may include in the communication to the SMF 420 Policy and Charging Control (PCC) rules per importance of a PDU set. The PCC rules may be derived according to information received from the XRM AF 410 or based on an operator configuration.

At 483, the SMF 420 establishes a QoS flow according to the QoS rules by the PCF 415 and configures the UPF to route packets of the XR application to a QoS flow, and, in addition, to enable PDU set handling. The SMF 420 also provides the QoS profile containing PDU set QoS requirements to the RAN 430 via the AMF 425. The AMF 425 may provide the QoS profile containing PDU set QoS requirements to the RAN 430 in an N2 Session Management (SM) container. Further, the AMF 425 may provide the QoS rules to the UE 435 in an N1 SM container.

At 484, the UPF 440 inspects the packets and determines packets belonging to a PDU set. The packet inspection may comprise inspecting the RTP packets. When the UPF 440 detects packets of a PDU set the UPF 440 marks the packets belonging to a PDU set within a GTP-U header. The GTP-U header information includes a PDU set sequence number and the size of the PDU set. The UPF 440 may also determine the importance of the PDU set either based on UPF 440 implementation means, information provided by the XRM AF 410 or information provided as metadata from an XRM application server. Based on the importance of the PDU set the UPF 440 may route the traffic to a corresponding QoS flow 1 (according to the rules received from the SMF 420) or include the importance of the PDU set within a GTP-U header. QoS flow 1 may comprise GTP-U headers, and these may include PDU set information.

At 485, the RAN 430 identifies packets belonging to a PDU set (based on the GTP-U marking) and handles the packets of the PDU set according to the QoS requirements of the PDU set provided by the SMF 420. RAN 430 may receive QFIs, QoS profile of QoS flow from SMF 420 (via AMF 425) during PDU session establishment/modification which includes PDSB and PSER. RAN 430 inspects GTP-U headers and ensures all packets of the same PDU set are handled according to the QoS profile. This may include packets of PDU set in a radio bearer carrying QoS flow 1. This may also include sending packets not belonging to the PDU set in a different radio bearer carrying QoS flow 2.

The above example relates to downlink (DL) traffic. Reciprocal processing is applicable to uplink (UL) traffic wherein the role of UPF 440 packet inspection is taken by the UE 435 which is expected to inspect uplink packets, determine packets belonging to a PDU set, and signal accordingly the PDU set to the RAN 430 for scheduling and resource allocation corresponding to an associated DRB capable of fulfilling the PDU set QoS requirements (i.e., PSDB and PSER). The low-level signaling mechanism associated with the UL UE-to-RAN information passing are up to the specification and implementations of RAN signaling procedures.

Herein, extended Reality (XR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and XR traffic model in the Technical Report TR 26.926 (v1.1.0) titled “Traffic Models and Quality Evaluation Methods for Media and XR Services in 5G Systems”, and decided the QoS requirements in terms of delay budget, data rate and error rate necessary for a satisfactory experience at the application level. These led to 4 additional 5G QoS Identifiers (5QIs) for the 5GS XR QoS flows. These 5Qis are defined in 3GPP TS 23.501 (v17.5.0), Table 5.7.4-1, presented there as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

The following additional assumptions have also been agreed:
NG-RAN is the only entity that drops packet of a PDU-set in case of congestion.
For a QoS flow there can be multiple priority PDU-sets. The NG-RAN drops the lower priority PDU-sets in case of congestions.
The NG-RAN drops all PDUs of a PDU-set

As a PDU-set may contain a plurality of PDUs, the NG-RAN dropping all the PDUs of a PDU-set may result in charging inconsistency given that the UPF marks packets sent in the downlink and reports the number of packets sent over the downlink to the charging function.

It is known that the NG-RAN can report packets sent and received over a secondary RAT. The information is disclosed in clause 4.21 of 3GPP TS 23.502 v 17.6.0 (September 2022) where the NG-RAN reports usage data at the AMF.

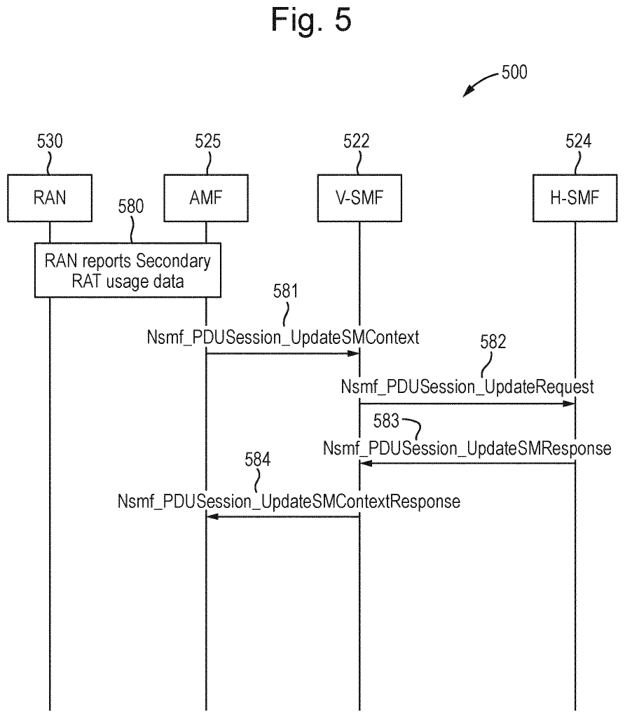

FIG. 5 illustrates a SMF Secondary RAT Usage Data Reporting procedure 500. The procedure 500 takes place between RAN 530, AMF 525, V-SMF 522 and H-SMF 524. In a specific scenario when the UE is roaming in a visited PLMN (e.g. V-PLMN), the UE may use home-route PDU Sessions where the PDU Session is anchored in the home PLMN (e.g. H-PLMN) and the PDU Session is setup over one S-NSSAI in the V-PLMN and another S-NSSAI in the H-PLMN. The prefix “H-” in front of the name of network function (NF) means that the NF is located in the H-PLMN, whereas the prefix “V-” in front of the name of NF means that the NF is located in the V-PLMN. The RAN 530, if it supports Dual Connectivity with Secondary RAT (using NR radio, E-UTRA radio, or unlicensed spectrum using NR or E-UTRA radio) and it is configured to report 580 Secondary RAT usage data for the UE, it shall include the Secondary RAT usage data for the UE to the AMF 525 in certain messages depending on certain conditions documented in 3GPP TS 23.502 v 17.6.0. The RAN 530 may comprise a base unit 104, a network node 300, a RAN 430 or an NG-RAN node 630 as described herein.

At 581, the AMF 525 forwards the N2 SM Information (Secondary RAT Usage Data) to the V-SMF 522 in a Nsmf_PDUSession_UpdateSMContext Request.

At 582, the V-SMF 522 sends the Nsmf_PDUSession_Update (Secondary RAT Usage Data) message to the H-SMF 524.

At 583, the H-SMF 524 acknowledges receiving the Secondary RAT Usage data for the UE.

At 584, the V-SMF 522 acknowledges receiving the Secondary RAT Usage data back to the AMF 525.

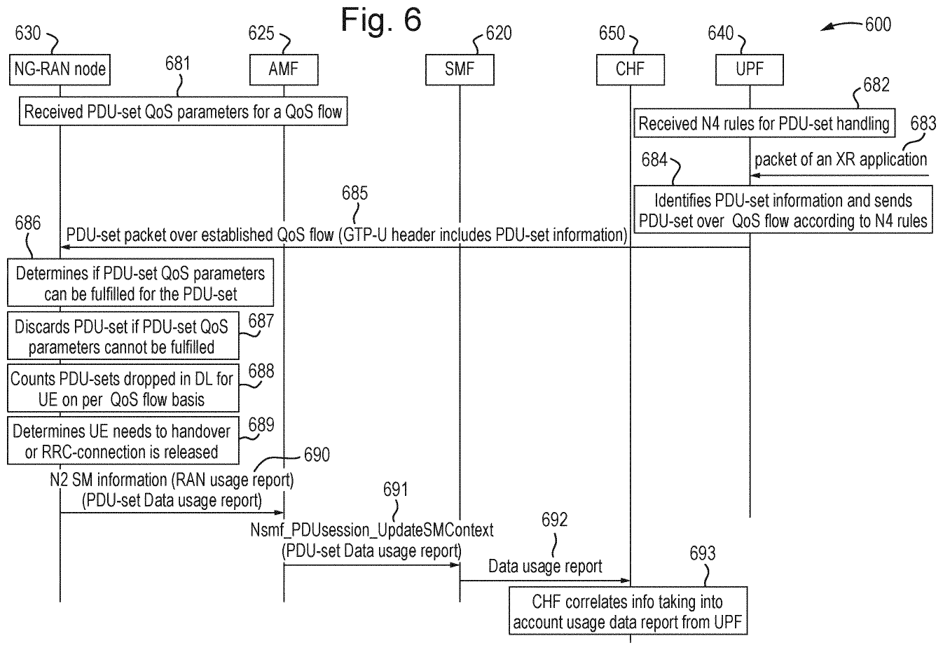

FIG. 6 illustrates a method 600 for charging for PDU sets in a wireless communication network. Specifically, FIG. 6 shows an NG-RAN node 630 reporting PDU-set(s) dropped to an AMF 625. The NG-RAN node 630 may comprise a base unit 104, a network node 300, a RAN 430, or a RAN 530 as described herein. FIG. 6 additionally shows an SMF 620, a CHF 650 and a UPF 640. The method 600 is an example of a solution whereby the Charging Function (CHF) 650 is made aware of PDU-sets dropped by NG-RAN 630. The CHF 650 uses this information for charging correlation. The solution described herein comprises the NG-RAN 630 reports the PDU-set(s) dropped to the AMF 625 by using a modified NG-RAN usage data report. The NG-RAN 630 may be referred to as an NG-RAN, a gNodeB.

At 681, the NG-RAN 630 receives within N2 SM information from the AMF 625, PDU set QoS parameters for the QoS flow namely, PDU Set Delay Budget and/or PDU Set Error Rate and whether all the PDUs of the PDU-set are required to be sent in the downlink and received by the UE.

At 682, the UPF 640 receives from the SMF 620 (based on PCC rules from the PCF), N4 rules that includes information to identify PDU-set and rules to send identified PDU-set via a QoS flow.

At 683, the UPF 640 receives (via N6) a packet of an XR application in the downlink.

At 684, the UPF 640 identifies if the received XR packet is part of a PDU-set.

At 685, the UPF 640 sends the PDU-set within a QoS flow according to N4 rules and includes within the GTP-U header PDU-set information (PDU-set identity and size).

At 686, when the NG-RAN 630 receives and identifies a PDU of a PDU-set in the downlink based on GTP-U header information, the NG-RAN 630 checks if the PDU-set QoS parameters of the QoS flow can be fulfilled.

At 687, if the PDU-set QoS parameters cannot be fulfilled the NG-RAN 630 may discard the PDU-set. The NG-RAN 630 may discard all PDUs of a PDU-set in case the PDU-set QoS parameters include information that the receiver requires all PDUs of a PDU-set.

At 688, the NG-RAN 630 counts the number of PDU-sets dropped in the downlink. A PDU-set may be dropped due to, e.g., congestion. The NG-RAN 630 is configured via OAM to count the number of packets dropped. In an alternative, an indication to report packets of a PDU-set dropped may be sent from the AMF 625 within N2 SM information (based on PCC rules provided by the PCF).

At 689, the NG-RAN 630 determines that the UE requires to handover or the RRC connection is released.

At 690, before handover takes place, or before the RRC connection is released, the NG-RAN 630 reports the dropped PDU-set within RAN usage report container in N2-SM information. The RAN usage report container includes a new PDU-set data usage report that includes information on the dropped PDU-set(s). The dropped PDU-set information includes a PDU-set identity and the size of the PDU-set (corresponding to the number of PDUs within a PDU-set).

At 691, the AMF 625 forwards this information to the SMF 620.

At 692, the SMF 620 reports Charging Data Records to the Charging Function (CHF) 650.

At 693, the CHF 650 removes from the records PDUs that were dropped by the NG-RAN 630.

In an alternative arrangement instead of the NG-RAN 630 reporting dropped PDU-sets, the NG-RAN 630 reports the PDUs of a PDU-set that are sent in downlink or received in the UL. The information is sent to the CHF 650 using similar procedure as described above in relation to FIG. 6, where the PDU-set information includes the number of PDUs for a UE sent in the downlink and/or uplink. The CHF 650 compares this information with the information provided by the UPF and, when determining charging, disregards any PDU-sets not delivered to the UE.

There is provided a network node of a wireless communication system, the network node comprising: a processor; and a memory coupled with the processor. The processor is arranged to cause the network node to: determine that the QoS parameters of at least one PDU-set cannot be fulfilled for a downlink PDU-set, the downlink PDU-set intended for delivery to a UE; discard the at least one downlink PDU-set for which the QoS parameters cannot be fulfilled; and report information indicating the at least one discarded PDU-set of the UE to a first network function.

The network node may comprise an NG-RAN. The first network function may comprise an AMF. The information indicating the at least one discarded PDU-sets may comprise a PDU-set data usage report. Where the first network function is not a charging function (CHF), the first network function may pass the reported information to the charging function (CHF).

As a result of the report of information indicating discarded PDU-sets to the first network function, this information can be passed on to a Charging Function (CHF), which is then able to remove from charging records PDUs that were dropped by the network node. As such, the charging records accurately reflect the PDUs that were delivered over the downlink, compensating for discarded PDUs.

The processor may be further arranged to receive information defining PDU-set QoS parameters, wherein the PDU set QoS parameters comprise at least one of: PDU set delay budget; PDU set error rate; and information defining whether all PDUs of a PDU set are required to be sent to a UE. The information defining PDU-set QoS parameters may be received via N2 SM interface.

The network node may be a first network node and the processor may be further arranged to: determine that the UE is to be handed over to a second network node; and wherein the reporting of information indicating the at least one discarded PDU-set of the UE to a first network function may be performed in response to determining that the UE is to be handed over to a second network node.

The processor may be further arranged to: determine that an RRC connection of the UE is to be released; and the reporting of information indicating the at least one discarded PDU-set of the UE to a first network function may be performed in response to determining that the RRC connection of the UE is to be released.

The information indicating discarded PDU-sets may include the identity and a size of at least one PDU-set. The information indicating discarded PDU-sets may identify PDU-sets that have been discarded. The information indicating discarded PDU-sets may identify PDU-sets that have been delivered. A comparison may be made between the PDU-sets that have been delivered and the starting PDU-sets so as to identify the PDU-sets that have been discarded. Such a comparison may be made at a charging function (CHF).

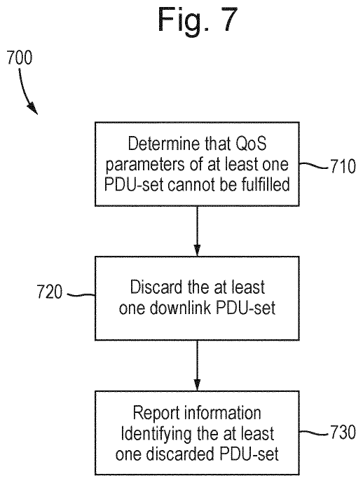

FIG. 7 illustrates a method 700 in a network node of a wireless communication system, the method 700 comprising: determining 710 that the QoS parameters of at least one PDU-set cannot be fulfilled for a downlink PDU-set, the downlink PDU-set intended for delivery to a UE; discarding 720 the at least one downlink PDU-set for which the QoS parameters cannot be fulfilled; and reporting 730 information indicating the at least one discarded PDU-set of the UE to a first network function.

In certain embodiments, the method 700 may be performed by a processor executing program code, for example, a microcontroller, a microprocessor, a CPU, a GPU, an auxiliary processing unit, a FPGA, or the like.

The network node may comprise an NG-RAN. The first network function may comprise an AMF. The information indicating the at least one discarded PDU-sets may comprise a PDU-set data usage report. Where the first network function is not a charging function (CHF), the first network function may pass the reported information to the charging function (CHF).

As a result of the report of information indicating discarded PDU-sets to the first network function, this information can be passed on to a Charging Function (CHF), which is then able to remove from charging records PDUs that were dropped by the network node. As such, the charging records accurately reflect the PDUs that were delivered over the downlink, compensating for discarded PDUs.

The method may further comprise receiving information defining PDU-set QoS parameters, wherein the PDU set QoS parameters comprise at least one of: PDU set delay budget; PDU set error rate; and information defining whether all PDUs of a PDU set are required to be sent to a UE. The information defining PDU-set QoS parameters may be received via N2 SM interface.

The network node may be a first network node and the method may further comprise: determining that the UE is to be handed over to a second network node; and the reporting of information indicating the at least one discarded PDU-set of the UE to a first network function is performed in response to determining that the UE is to be handed over to a second network node.

The method may further comprise determining that an RRC connection of the UE is to be released; and whereby the reporting of information indicating the at least one discarded PDU-set of the UE to a first network function is performed in response to determining that the RRC connection of the UE is to be released.

The information indicating discarded PDU-sets may include the identity and a size of at least one PDU-set. The information indicating discarded PDU-sets may identify PDU-sets that have been discarded. The information indicating discarded PDU-sets may identify PDU-sets that have been delivered. A comparison may be made between the PDU-sets that have been delivered and the starting PDU-sets so as to identify the PDU-sets that have been discarded. Such a comparison may be made at a charging function (CHF).

When NG-RAN drops PDUs of a PDU set there may be a charging offset issue for the downlink packets as the UPF counts for charging all packets sent on the downlink. Note that the charging function does not take into account any packets dropped by the NG-RAN (dropped due to congestion for example). However, by way of example for XR, there is an assumption that the NG-RAN will drop all packets of a PDU-set in case of congestion. PDU-sets may be dropped for other reasons and any of which can cause a charging discrepancy as a PDU-set may contain multiple packets (PDUs) considerably increasing the number of packets dropped.

The solution presented herein comprises re-using an existing reporting mechanism for the NG-RAN to report RAN usage data report to a network function. This reporting mechanism is modified to report data sent in UL/DL on a secondary RAT. Additionally, the NG-RAN may report the PDU-set(s) dropped within RAN usage data report.

Prior art is disclosed in 3GPP TS 23.502 v17.6.0 where the NG-RAN reports data sent in DL or UL for dual connectivity when data is sent/received over the secondary RAT. Such procedure cannot be used to report PDU-set dropped.

Main embodiment is that the NG-RAN reports to the AMF PDU-set(s) dropped, e.g., due to congestion.

Accordingly, there is provided a method comprising: receiving via N2 SM information PDU set QoS parameters wherein the PDU set QoS parameters consists of PDU set delay budget, PDU set error rate and information whether all PDUs of a PDU set are required to be sent to a UE; determining that the PDU-set QoS parameters cannot be fulfilled for a downlink PDU-set; discarding one or more PDU-sets due to PDU-set QoS parameters not being able to be fulfilled; determining a UE needs to be handed over to a second NG-RAN (or determining the RRC connection of a UE needs to be released); and reporting within first information discarded PDU-sets to a first network function (AMF) wherein the first information includes a PDU-set identity and size of a PDU-set.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal

Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: UE, User Equipment; PDU, Packet Data Unit; PDU-set, Packet Data Unit set; UL, Uplink; DL, Downlink; QoS, Quality of Service; XR, Extended Reality; PSDB, PDU Set Delay Budget; PDB, Packet Delay Budget; PSER, PDU Set Error Rate; and CHF, Charging Function.

1. A network node for wireless communication, the network node comprising:
at least one memory; and
at least one processor coupled with the at least one memory and configured to cause the network node to:
determine that quality of service (QoS) parameters of at least one protocol data unit (PDU) set cannot be fulfilled for a downlink PDU set, the downlink PDU set intended for delivery to a user equipment (UE);
discard the at least one downlink PDU set for which the QoS parameters cannot be fulfilled; and
report the discarded at least one downlink PDU set of the UE to a network function.

2. The network node of claim 1, wherein the at least one processor is configured to cause the network node to receive first information defining PDU set QoS parameters, wherein the PDU set QoS parameters comprise at least one of:
PDU set delay budget;
PDU set error rate; or
second information defining whether all PDUs of the at least one PDU set are required to be sent to the UE.

3. The network node of claim 1, wherein the network node is a first network node and wherein the at least one processor is configured to cause the network node to report the discarded at least one downlink PDU set of the UE to the network function in response to a determination that the UE is to be handed over to a second network node.

4. The network node of claim 1, wherein the at least one processor is configured to cause the network node to report the discarded at least one downlink PDU set of the UE to the network function in response to a determination that a radio resource control (RRC) connection of the UE is to be released.

5. The network node of claim 1, wherein information indicating the discarded at least one downlink PDU set includes an identity and a size of the discarded at least one downlink PDU set.

6. The network node of claim 1, wherein information indicating the discarded at least one downlink PDU set identifies PDU sets that have been discarded.

7. The network node of claim 1, wherein information indicating the discarded at least one downlink PDU set identifies PDU sets that have been delivered.

8. A method performed by a network node of a wireless communication system, the method comprising:
determining that quality of service (QoS) parameters of at least one protocol data unit (PDU) set cannot be fulfilled for a downlink PDU set, the downlink PDU set intended for delivery to a user equipment (UE);
discarding the at least one downlink PDU set for which the QoS parameters cannot be fulfilled; and
reporting the discarded at least one downlink PDU set of the UE to a network function.

9. The method of claim 8, further comprising receiving first information defining PDU set QoS parameters, wherein the PDU set QoS parameters comprise at least one of:
PDU set delay budget;
PDU set error rate; or
second information defining whether all PDUs of the at least one PDU set are required to be sent to the UE.

10. The method of claim 8, wherein the network node is a first network node and the method further comprising:
determining that the UE is to be handed over to a second network node; and
wherein the reporting the discarded at least one downlink PDU set of the UE to the network function is performed in response to the determining that the UE is to be handed over to the second network node.

11. The method of claim 8, further comprising:
determining that a radio resource control (RRC) connection of the UE is to be released; and
wherein the reporting the discarded at least one downlink PDU set of the UE to the network function is performed in response to the determining that the RRC connection of the UE is to be released.

12. The method of claim 8, wherein information indicating the discarded at least one downlink PDU set includes an identity and a size of the discarded at least one downlink PDU set.

13. The method of claim 8, wherein information indicating the discarded at least one downlink PDU set identifies PDU sets that have been discarded.

14. The method of claim 8, wherein information indicating the discarded at least one downlink PDU set identifies PDU sets that have been delivered.

15. A processor for wireless communication, comprising:
at least one controller coupled with at least one memory and configured to cause the processor to:
determine that quality of service (QoS) parameters of at least one protocol data unit (PDU) set cannot be fulfilled for a downlink PDU set, the downlink PDU set intended for delivery to a user equipment (UE);
discard the at least one downlink PDU set for which the QoS parameters cannot be fulfilled; and
report the discarded at least one downlink PDU set of the UE to a network function.

16. The processor of claim 15, wherein the at least one controller is configured to cause the processor to receive first information defining PDU set QoS parameters, wherein the PDU set QoS parameters comprise at least one of:
PDU set delay budget;
PDU set error rate; or
second information defining whether all PDUs of the at least one PDU set are required to be sent to the UE.

17. The processor of claim 15, wherein the at least one controller is configured to cause the processor to report the discarded at least one downlink PDU set of the UE to the network function in response to a determination that the UE is to be handed over from a first network node to a second network node.

18. The processor of claim 15, wherein the at least one controller is configured to cause the processor to report the discarded at least one downlink PDU set of the UE to the network function in response to a determination that a radio resource control (RRC) connection of the UE is to be released.

19. The processor of claim 15, wherein information indicating the discarded at least one downlink PDU set includes an identity and a size of the discarded at least one downlink PDU set.

20. The processor of claim 15, wherein information indicating the discarded at least one downlink PDU set identifies at least one of PDU sets that have been discarded or PDU sets that have been delivered.
